(19) United States
(12) Patent Application Publication
(10) Pub. No.: US 2005/0260353 A1
(43) Pub. Date: Nov. 24, 2005

(54) Method of fabricating an iron-on interlining, and an iron-on interlining obtained thereby

(76) Inventors: Jean Lefebvre, Estree-Mons (FR); Francois Labre, Saint-Quentin (FR); Yves LeHouarner, Flamicourt (FR)

Correspondence Address: KENYON & KENYON, 1500 K STREET NW, SUITE 700, WASHINGTON, DC, 20005, US

(21) Appl. No.: 11/132,323

(22) Filed: May 19, 2005

(30) Foreign Application Priority Data
May 24, 2004 (FR) 0405586

(51) Int. Cl. B05D 1/36

(52) U.S. Cl. 427/412; 427/487

(57) ABSTRACT

The method of fabricating an iron-on interlining consists in silkscreen printing to deposit spots directly on the surface of a woven or non-woven fabric, which spots are of a polymer that forms a protective underlayer, in depositing an outer layer of hot-stick polymer on the underlayer, and in subjecting the fabric to heat treatment so as to melt said hot-stick polymer onto said protective underlayer. The polymer forming the underlayer is a polymer that is not cured but that is curable by applying electron bombardment, and, in addition, it is of polymeric structure that is compatible with the structure of the hot-stick polymer of the outer layer. After heat treatment, the interlining is subjected to the action of irradiation, in particular electron bombardment, so as to cure the polymer of said underlayer. The polymer of the underlayer and the polymer of the outer layer preferably have the same polymeric structure, being made of copolyamide or of polyethylene.

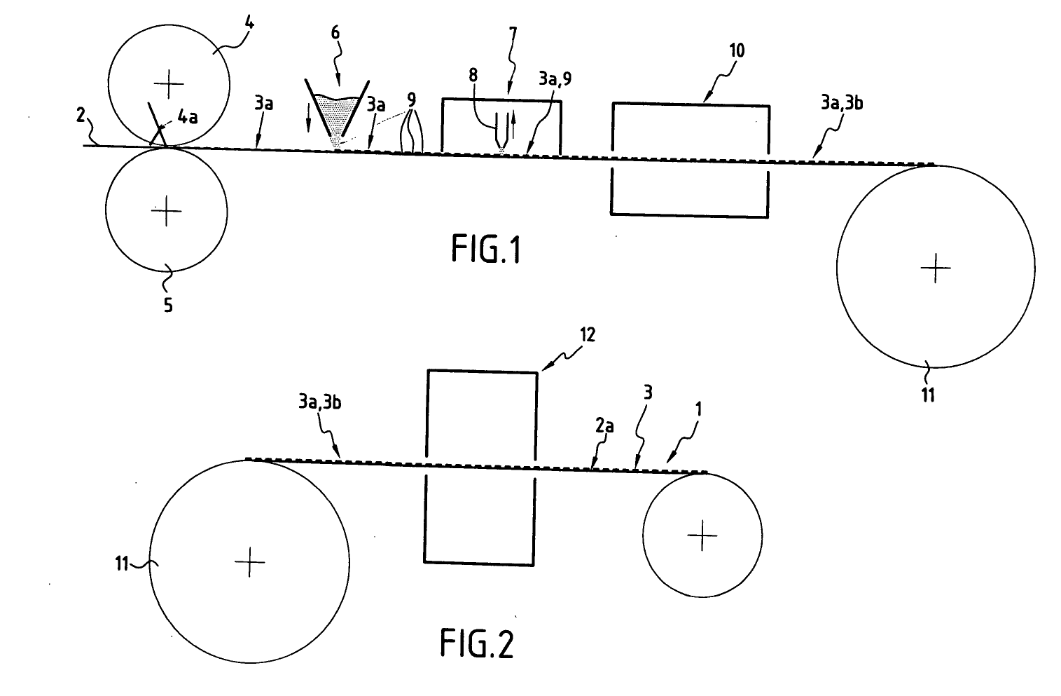

The present invention relates to the field of iron-on interlinings which are woven or non-woven fabric having a hot-stick polymer applied to one face thereof in the form of spots, said polymer being suitable subsequently for adhering to a garment that needs to be reinforced by applying a certain amount of heat and pressure.

### BACKGROUND OF THE INVENTION

Amongst the problems that are encountered in the field of iron-on interlining, one of the most difficult to solve lies in the risk of the adhesive bleeding through the interlining while the iron-on interlining is being pressed hot against the garment to be reinforced. The temperature chosen for iron-on application must enable the hot-stick polymer to melt so that the molten polymer can spread and bond with the surface fibers or filaments of the garment. However, it can happen that the polymer flows through the fibers or filaments and appears on the other face of the interlining. This can spoil appearance if the interlining is to be apparent, e.g. forming the rear face of the garment. In addition, and above all, such bleed-through has the effect of locally increasing the stiffness of the interlining and thus of the garment, which can be contrary to the desired effect. It can also lead to bonding on lining cloth such as linings and folded-back portions of cloth, thereby degrading the quality of the garment.

One solution to this problem, as described in particular in document FR 2 177 038, consists in placing spots on the interlining, which spots are constituted by at least two superposed layers formed by hot-stick polymers of different compositions, such that the underlayer which is applied directly to the interlining flows thermoplastically to a smaller extent than the outer layer, under normal temperature and pressure conditions for applying iron-on interlining to the garment. This difference in flow properties can be obtained in particular by using for the underlayer a polymer that possesses greater melting viscosity and/or a temperature range at which melting starts that is higher than that of the polymer of the outer layer. Thus, when applying the iron-on interlining to the garment, the polymer forming the underlayer creates a kind of protective barrier that prevents the spot of adhesive flowing over the back face of the interlining.

The outer layer may be applied in particular by dusting on particles of polymer and then by sucking up those particles that do not adhere to the underlayer, which is initially deposited in a pasty state.

After the polymer spots constituted by the underlayer and the outer layer have been deposited, the interlining can be put into a heating enclosure in order to melt the hot-stick polymer particles of the outer layer. It is appropriate for the iron-on interlining to be capable of being rolled up and handled without any risk of losing hot-stick polymer particles constituting the outer layer. The purpose of such heat temperature is thus to consolidate the adhesive spots by creating bonding between the polymer of the underlayer and that of the outer layer. In addition, the heating operation serves to eliminate the solvent from the still-pasty underlayer.

That technique nevertheless presents a limit that lies in the risk of hot-stick polymer spots delaminating between the underlayer and the outer layer. Even if the underlayer and the outer layer bond to each other because the particles constituting the outer layer have melted, this bonding usually turns out to be insufficient to ensure that there is no risk of separation between the iron-on interlining and the garment when traction is applied between those two elements, with such separation taking place specifically in the bonding zones between the underlayers and the outer layers, which zones constitute a zone of weakness.

Documents EP 0 855 146 and EP 1 314 366 have already attempted to mitigate that drawback by returning to a technique that implements polymer spots that are not made up of an underlayer and an outer layer, but that are one-piece polymer spots in which the protective barrier effect is created by locally modifying the polymer constituting the spot.

In document EP 0 855 146, the hot-melt polymer spots contain a radical activator agent and one of the faces of the interlining is subjected to electron bombardment with the penetration depth of the electrons in the hot-melt polymer spots being adjusted so as to modify the physicochemical properties of the hot-melt polymer selected from melting temperature and viscosity, over a thickness e that is limited compared with the mean thickness of the polymer spots.

It is that modification of the physicochemical properties of the hot-melt polymer that makes it possible to create a distinction between the top portion of the polymer spot which is to act as the hot-stick polymer, and the bottom portion of the polymer spot, close to the interlining, which acts as a protective barrier to prevent the top portion of the spot flowing onto the back of the interlining while the iron-on interlining is being pressed hot against the garment to be reinforced.

In document EP 1 314 366, the presence of the radical agent in the polymer constituting each spot is replaced by functionalizing said polymer.

That solution avoids the phenomenon of delamination, but nevertheless presents drawbacks.

Firstly, it requires fine adjustment of the penetration depth of electrons in the polymer spots, which adjustment is made all the more difficult in that it is the back face of the interlining that is subjected to electron bombardment, so it is necessary to take account of any effects that might be due to the presence of the interlining.

In addition, it is necessary to achieve a completely uniform mixture of the radical activator in each spot of the polymer, or possibly complete uniformity in the functionalization of the polymer constituting each spot.

Furthermore, that technique leads to an extra cost in terms of consumables that is not technically justified; it is the total volume of each spot that contains a radical agent, while the polymer is functionalized only over a small fraction of the volume, of thickness e, and it is only this small volume that requires the radical agent or the functionalization.

### OBJECT AND SUMMARY OF THE INVENTION

The object of the present invention is to mitigate the drawbacks of two superposed layers delaminating in the technique described by document FR 2 177 038 while avoiding the problems raised by the two documents EP 0 855 146 and EP 1 314 366.

This object is fully achieved by a method of fabricating an iron-on interlining that consists in:

a) in using silkscreen printing to deposit polymer spots directly on the surface of a woven or non-woven fabric, which spots form a protective underlayer, said polymer being a non-cured hot-melt polymer that is curable by applying electron bombardment;

b) depositing an outer layer of hot-stick polymer on the underlayer, said outer layer not being curable by applying electron bombardment and being of a polymeric structure that is compatible with that of the polymer of the underlayer;

c) in subjecting the fabric to heat treatment so as to melt said hot-stick polymer on said protective underlayer; and

d) after heat treatment, in subjecting the interlining to the action of electron bombardment so as to cure the polymer of said underlayer.

Thus, during the heat treatment, the hot-stick polymer in the molten state interpenetrates the polymer structure of the polymer of the underlayer because of the compatibility of their respective polymeric structures.

Preferably, the polymer of the underlayer and the polymer of the outer layer have the same polymeric structure, mainly comprising copolyamide or polyethylene or possibly copolyester or polyurethane.

As a result, the heat treatment leads not only to the hot-stick polymer of the outer layer melting, but also to the curable polymer of the underlayer melting, thus ensuring that the structure of each polymer spot becomes uniform at the surface of the interlining.

The same polymeric structure for the polymer of the underlayer and for the polymer of the outer layer can be obtained either by using a polymer that is exactly the same, but with a radical agent added to the underlayer, or else by using polymers of different grades, thus also making it possible to vary melting points.

Electron bombardment is preferably applied after the polymer spots have cooled.

In a variant implementation, the heat treatment and the electron bombardment are operations that are independent, being performed in separate installations.

It is entirely possible to roll up the interlining after the polymer spots have been subjected to the heat temperature and have cooled.

It is thus possible to use a conventional installation for depositing the polymer spots, applying heat treatment to them and cooling them down, and to use another specific installation for applying radiation under different operating conditions, in particular in terms of speed.

This makes it possible to optimize the cost of fabricating iron-on interlining using the method of the invention.

### BRIEF DESCRIPTION OF THE DRAWING

The present invention will be better understood on reading the following description of examples of iron-on interlinings obtained on the installation shown diagrammatically in the accompanying figures.

### MORE DETAILED DESCRIPTION

The iron-on interlining 1, which is fabricated in a manner described below, comprises firstly an interlining 2 which is a knitted or woven or non-woven fabric, and secondly spots 3 of polymer which are disposed on one of the faces 2a of the interlining.

Each polymer spot 3 is made up of two layers which are deposited in succession on the interlining 2, i.e. an underlayer 3a and an outer layer 3b.

The outer layer 3b is made of a hot-stick polymer.

The underlayer 3a is made of a cured polymer having polymeric structure that is compatible with the structure of the polymer of the outer layer 3b, and preferably a cured polymer having the same polymeric structure as the polymer of the outer layer 3b.

While the underlayer 3a is being deposited on the interlining 2, the curable polymer is as yet uncured, with curing taking place during the process of fabricating the iron-on interlining 1, as explained below.

The underlayer 3a of each polymer spot 3 is deposited by using a silkscreen print cylinder 4 co-operating firstly with an inner scraper 4a and secondly with a backing cylinder 5.

The underlayer 3a is in the form of a paste or a dispersion in a solvent, in particular an aqueous dispersion, and it is deposited directly on the interlining 2 as it passes over the tangential line between the silkscreen printing cylinder 4 and the backing cylinder 5.

An outer layer 3b is subsequently deposited on each underlayer 3a.

In the example shown, this deposition is performed by using a spray device 6 to dust the hot-stick polymer in the form of particles onto the interlining 2 after it has been coated in the spots of underlayer 3a.

Because said underlayer spots 3a are in paste or dispersion form, the particles of hot-stick polymer that come into contact with said underlayer spots stick to the surfaces thereof.

The particles that drop onto the interlining 2 without coming into contact with the underlayer spots 3a do not stick to said interlining 2 and are therefore easily removed.

This removal of excess particles that do not stick to the underlayer spots 3a is performed in a remover device 7, in particular by suction 8.

Thus, at the outlet from the remover device 7, the coated face 2a of the interlining 2 has an array of underlayer spots 3a each surmounted by particles of hot-stick polymer 9.

The interlining as coated in this way in two layers then passes through a heating enclosure 10 under conditions of temperature and treatment duration that enable the particles 9 to be melted and that also enable the solvent to be evaporated from the underlayers 3a.

During this melting, the hot-stick polymer interpenetrates into the structure of the polymer forming the underlayer 3a, which interpenetration contributes to making the polymer spots 3 uniform, and therefore reduces any risk of delamination between the underlayer 3a and the outer layer 3b.

This risk of delamination is further reduced when the polymer used for the underlayer 3a is a polymer that has the same polymeric structure as the hot-stick polymer of the outer layer 3b, and is likewise caused to melt during the heat treatment.

After passing through the heating enclosure 10 and after cooling down, in particular with the help of nozzles or strips for blowing cold air or by passing over one or more cooled cylinders, the interlining 2 coating the spots of underlayer 3a and outer layer 3b is rolled up to form a roll 11. In another installation, possibly on different premises, the roll 11 is subjected to an application of electron bombardment for curing the polymer of the underlayer 3a, thereby obtaining polymer spots 3 made in accordance with the method of the invention.

This electron bombardment is achieved using an industrial electron gun.

Contrary to the provisions of documents EP 0 855 146 and EP 1 134 366, there is no longer any need to adjust the penetration of the electron beam very accurately. It suffices for this penetration to be deep enough into the underlayer 3a to enable the polymer of said underlayer to cure the polymer of said underlayer.

If the electron beam also penetrates into the outer layer 3b, that is of no consequence since the hot-stick polymer constituting said outer layer 3b is not itself curable by electron bombardment.

Curing the polymer of the underlayer 3a modifies the physicochemical properties of said polymer, in particular its melting temperature and/or its viscosity such that in the manner described in the above-cited documents, the underlayer 3a forms the desired protective barrier.

Preferably, the hot-melt polymer spots forming the protective underlayer contain a radical activator, e.g. an acrylate type monomer, selected in particular from trimethylolpropane trimethacrylate and trimethylolpropane triacrylate.

In a specific implementation given in non-exhaustive manner, the outer layer 3b is made of particles 9 of copolyamide, and the underlayer 3a is made from a dispersion of copolyamide powder mixed with a radical activator constituted, specifically, by trimethylolpropane trimethacrylate at a concentration of 10% by weight of radical activator relative to the polyamide.

Comparative tests have been carried out between this iron-on interlining (A) and a conventional interlining (B) in which each polymer spot was formed by an outer layer of the same polyamide hot-stick polymer and the protective underlayer was made of high density polyethylene.

From those tests, it was found that the iron-on interlining (A) of the invention presents an adhesive force which, at the usual temperatures for sticking the interlining on the garment, is 20% to more than 50% greater than that obtained using the conventional interlining (B), depending on the temperature used.

Those tests also show that bleed-through, tested under the conditions set out in document EP 0 855 146, present values that are comparable for the iron-on interlining (A) of the invention and for the conventional interlining (B).

The present invention is not limited to the above implementations.

The curable polymer of the underlayer 3a may naturally be a functionalized polymer as described in document EP 1 314 366.

Under such circumstances, the spots of hot-melt polymer forming the protective underlayer placed on a functional polymer have functional groups generating free radicals under the action of electron bombardment, and functional groups suitable for reacting with the free radicals as formed thereby.

The outer layer spots 3b may also be deposited using a silkscreen printing cylinder identical to that used for depositing the underlayer spots 3a and operating accurately synchronously therewith so that the outer layer spots 3b are deposited on the underlayer spots 3a.

1. A method of fabricating an iron-on interlining, the method consisting:
a) in using silkscreen printing to deposit polymer spots directly on the surface of a woven or non-woven fabric, which spots form a protective underlayer, said polymer being a non-cured hot-melt polymer that is curable by applying electron bombardment;
b) depositing an outer layer of hot-stick polymer on the underlayer, said outer layer not being curable by applying electron bombardment and being of a polymeric structure that is compatible with that of the polymer of the underlayer;
c) in subjecting the fabric to heat treatment so as to melt said hot-stick polymer on said protective underlayer; and
d) after heat treatment, in subjecting the interlining to the action of electron bombardment so as to cure the polymer of said underlayer.

2. A method according to claim 1, wherein the polymer of the underlayer and the polymer of the outer layer have the same polymeric structure, being constituted in particular by copolyamide or polyethylene.

3. A method according to claim 1, wherein the electron bombardment is applied after the polymer spots have cooled.

4. A method according to claim 3, wherein the heat treatment and the application of radiation are operations that are independent, being performed on separate installations.

5. A method according to claim 1, wherein the spots of hot-melt polymer forming the protective underlayer contain a radical activator, e.g. a monomer of acrylate type, and selected in particular from trimethylolpropane trimethacrylate and trimethylolpropane triacrylate.

6. A method according to claim 5, wherein the outer layer is made from particles of copolyamide and the underlayer is made from a dispersion of copolyamide powder mixed with a radical activator, e.g. trimethylolpropane trimethacrylate at a concentration of 10% by weight radical activator relative to the polyamide.

7. A method according to claim 1, wherein the spots of hot-melt polymer forming the protective underlayer are based on a functional polymer having functional groups for generating free radicals under the action of electron bombardment and functional groups suitable for reacting with the free radicals formed thereby.
